(19) United States
(12) Patent Application Publication
(10) Pub. No.: US 2023/0334986 A1
(43) Pub. Date: Oct. 19, 2023

(54) METHOD OF PERFORMING GREEN WAVE COORDINATION CONTROL, ELECTRONIC DEVICE AND STORAGE MEDIUM

(71) Applicant: Apollo Intelligent Connectivity (Beijing) Technology Co., Ltd., Beijing (CN)

(72) Inventors: Yu MEI, Beijing (CN); Weicen LING, Beijing (CN); Xiaoqin DOU, Beijing (CN)

(21) Appl. No.: 18/027,219

(22) PCT Filed: Nov. 15, 2021
(86) PCT No.: PCT/CN2021/130618

§ 371 Date: Mar. 20, 2023

(30) Foreign Application Priority Data
Aug. 17, 2021 (CN) 202110945917.9

(51) Int. Cl. G08G 1/081

(52) U.S. Cl. CPC G08G 1/081

(57) ABSTRACT

A method of performing green wave coordination control, an apparatus of performing green wave coordination control, an electronic device, and a storage medium, which relate to a field of intelligent transportation, and in particular, to a field of traffic control. The method includes: obtaining (S210) an intersection parameter and a green wave parameter of n intersections on a preset road; calculating (S220) a duration of green wave travel for each road segment according to a green wave speed for the preset road; determining (S230) a constraint of green wave coordination according to the intersection parameter, the green wave parameter and the duration of green wave travel; determining (S240) an objective function of green wave coordination according to the forward green wave bandwidth and the reverse green wave bandwidth of each road segment; and performing green wave coordination control (S250) according to the constraint and the objective function.

### CROSS REFERENCE TO RELATED APPLICATION(S)

This application is a National Stage Application of International Application No. PCT/CN2021/130618, filed on Nov. 15, 2021, entitled “METHOD AND APPARATUS OF PERFORMING GREEN WAVE COORDINATION CONTROL, ELECTRONIC DEVICE AND STORAGE MEDIUM”, which claims priority to Chinese Patent Application No. 202110945917.9, filed on Aug. 17, 2021, which are incorporated herein in their entireties by reference.

### TECHNICAL FIELD

The present disclosure relates to a field of intelligent transportation technology, in particular to traffic control technology. Specifically, the present disclosure relates to a method of performing green wave coordination control, an electronic device and a storage medium.

### BACKGROUND

Green wave coordination control is to let a vehicle to encounter a green light when passing through each intersection on a designated road at a certain speed. Green wave coordination control may ensure the smooth flow of an urban road, which is important for urban traffic control.

### SUMMARY

The present disclosure provides a method of performing green wave coordination control, an electronic device and a storage medium.

According to an aspect of the present disclosure, there is provided a method of performing green wave coordination control, including: obtaining an intersection parameter and a green wave parameter of n intersections on a preset road, wherein the green wave parameter includes a forward green wave bandwidth and a reverse green wave bandwidth of each road segment between the n intersections, and n is an integer greater than or equal to 2; calculating a duration of green wave travel for each road segment according to a green wave speed for the preset road; determining a constraint of green wave coordination according to the intersection parameter, the green wave parameter and the duration of green wave travel; determining an objective function of green wave coordination according to the forward green wave bandwidth and the reverse green wave bandwidth of each road segment; and performing green wave coordination control according to the constraint and the objective function.

According to another aspect of the present disclosure, there is provided an electronic device including: at least one processor; and a memory communicatively coupled with the at least one processor, wherein the memory executable by the at least one processor, and the instructions, when executed by the at least one processor, cause the at least one processor to implement the method according to the disclosure.

According to another aspect of the present disclosure, there is provided a non-transitory computer-readable storage medium having computer instructions stored thereon, wherein the computer instructions are configured to cause a computer to implement the method according to the disclosure.

It should be understood that content described in this section is not intended to identify key or important features in the embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used for better understanding of the solution and do not constitute a limitation to the present disclosure, and wherein:

FIG. 1 shows a schematic scenario in which a method of performing green wave coordination control according to an embodiment of the present disclosure may be applied;

FIG. 2 shows a schematic flowchart of a method of performing green wave coordination control according to an embodiment of the present disclosure;

FIG. 3 shows a schematic diagram of signal relationship between a coordination phase and a non-coordination phase according to an embodiment of the present disclosure;

FIG. 4 shows a schematic diagram of signal space-time for the method of performing green wave coordination control according to an embodiment of the present disclosure;

FIG. 5 shows a block diagram of an apparatus of performing green wave coordination control according to an embodiment of the present disclosure;

FIG. 6 shows a block diagram of an electronic device for performing green wave coordination control according to an embodiment of the present disclosure.

### DETAILED DESCRIPTION OF EMBODIMENTS

Exemplary embodiments of the present disclosure will be described below with reference to the accompanying drawings, which include various details of the embodiments of the present disclosure to facilitate understanding and should be considered as merely exemplary. Therefore, those of ordinary skilled in the art should realize that various changes and modifications may be made to the embodiments described herein without departing from the scope and spirit of the present disclosure. Likewise, for clarity and conciseness, descriptions of well-known functions and structures are omitted in the following description.

Performing green wave coordination control refers to adjust the time at which the green light for each intersection on a preset road is turned on, so as to make the vehicle encounter the green light all the way when driving at a certain speed, and the certain speed mentioned above is a green wave speed.

In current green wave coordination control method, the green wave speed is usually obtained by a detector, such as an inductive coil, an electric police, or a radar, etc. However, since the green wave speed fluctuates with a traffic flow, the green wave speed obtained by the detector is not a real-time green wave speed. Therefore, green wave coordination control always fails due to lacking of real-time green wave speed data and lacking of the ability of dynamically coordinating for a change of the real-time green wave speed in coordination control.

Collecting, storing, using, processing, transmitting, providing, and disclosing etc. of the personal information of the user involved in the present disclosure all comply with the relevant laws and regulations, are protected by essential security measures, and do not violate the public order and morals. According to the present disclosure, personal information of the user is acquired or collected after such acquirement or collection is authorized or permitted by the user.

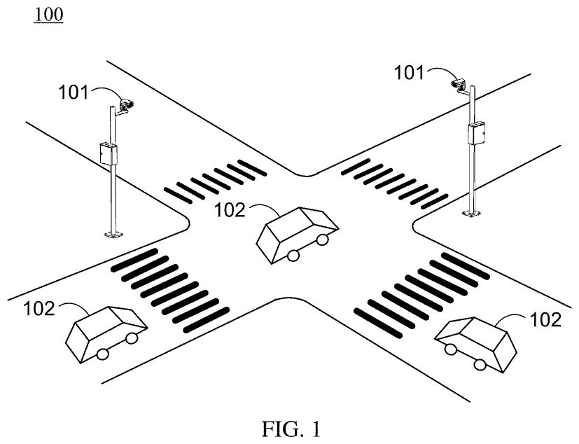

FIG. 1 shows a schematic scenario in which a method of performing green wave coordination control according to an embodiment of the present disclosure may be applied. It should be noted that FIG. 1 is only an example for a system architecture applied by the embodiments of the present disclosure, so as to help those of ordinary skilled in the art to understand technical contents of the present disclosure, but it does not mean that the embodiments of the present disclosure may not be used for other devices, systems, environments or scenes.

As shown in FIG. 1, a scene 100 may be an intersection on a preset road. A plurality of traffic lights 101 are disposed at the intersection. There are multiple vehicles 102 driving on the road. Performing green wave coordination control for the preset road is to adjust the time instant at which the green light of the traffic light 101 for each intersection on the preset road is turned on, such that the vehicles 102 encounters a green light when arriving each intersection at a specified speed. The specified speed is the green wave speed. Green wave speed may be a real-time speed that is dynamically changed with traffic flow.

For example, there are n intersections on the preset road, and n may be an integer greater than or equal to 2. In an example, n may be a value of 2 to 10. i may represent a sequence number of the intersection, i=1, 2, . . . , n. A direction along which the vehicle drives from an i^{th} intersection to an (i+1)^{th} intersection may be referred as upward (or forward), and a direction along which the vehicle drives from the (i+1)^{th} intersection to the i^{th} intersection may be referred as downward (or reverse). Green wave coordination control in both the forward direction and the reverse direction is referred as a two-way green wave coordination control. The two-way green wave coordination control may cause both the vehicles driving in the forward direction and the vehicles driving in the reverse direction to encounter the green light all the way at the green wave speed.

A width of a band during which a vehicle 102 driving at the green wave speed on the preset road as described above is capable of continuously passing through respective intersections with green light, is referred as a green wave bandwidth or a green wave width.

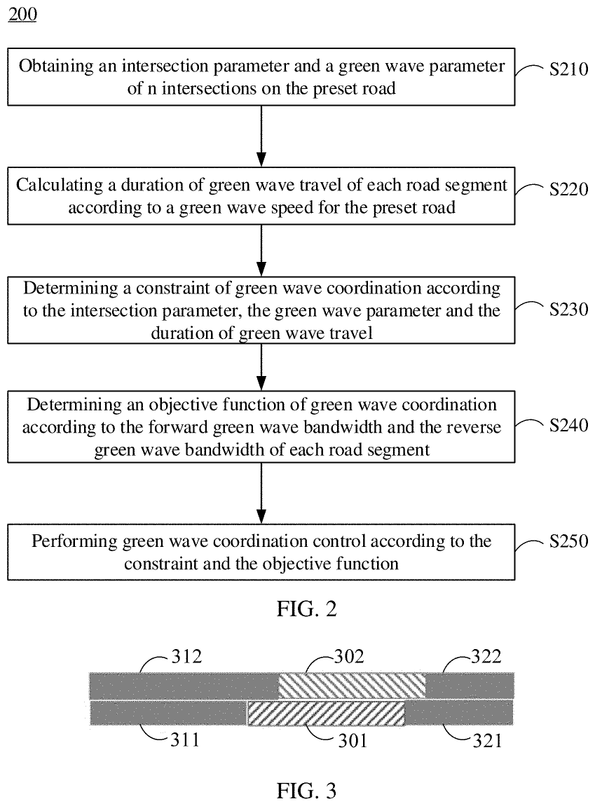

FIG. 2 shows a schematic flowchart of a method of performing green wave coordination control according to an embodiment of the present disclosure.

As shown in FIG. 2, the method 200 of the performing green wave coordination control may include operations S210 to S250.

In operation S210, the intersection parameter and the green wave parameter of n intersections are obtained on the preset road.

For example, the intersection may be a T-junction or a crossroad. n may be an integer greater than or equal to 2.

Each of the n intersections may include a traffic light having a plurality of phases. The traffic light having a plurality of phases may include e.g. traffic lights disposed at different orientations (e.g., east, west, south, north, southeast, northwest, etc.). At least one of the plurality of phases may be designated to participate in the green wave coordination control, the phase designated to participate in the green wave coordination control is referred as reference phase or coordination phase, and a phase other than the coordination phase among a plurality of phases is referred as non-coordination phase.

The intersection parameter may include a lighting period of the traffic light for the intersection. The lighting period is a time period during which the traffic light renders all the light colors in sequence for one round, that is, a sum of the time periods of rendering respective light colors; or a time period from a time instant at which the green light in a phase (such as the coordination phase) starts to light up to a time instant at which the green light starts to light up next time. It should be understood that the length of the lighting period may be a sum of time lengths for the traffic lights in all the phases to render green light in sequence for one round.

The intersection parameter may further include a ratio of a lighting duration of a green light in the coordination phase to the lighting period for the intersection, a ratio of a lighting duration of a green light in the non-coordination phase to the lighting period for the intersection, and a length of each road segment between the n intersections, etc. In an application of the two-way green wave coordination control, the intersection parameter includes a forward intersection parameter and a reverse intersection parameter, for example, a distance between the i^{th} intersection and the (i+1)^{th} intersection in a forward direction, and a distance between the i^{th} intersection and the (i+1)^{th} intersection in a reverse direction.

The green wave parameter may include a green wave bandwidth of each road segment. In an application of the two-way green wave coordination control, the green wave parameter includes a forward green wave parameter and a reverse green wave parameter, for example, the forward green wave bandwidth of the road segment between the i^{th} intersection and the (i+1)^{th} intersection, and the reverse green wave bandwidth of the road segment between the i^{th} intersection and the (i+1)^{th} intersection.

In operation S220, a duration of green wave travel for each road segment is calculated according to a green wave speed for the preset road.

For example, the green wave speed for the preset road may be a calculated real-time green wave speed. The duration of green wave travel for each road segment may be calculated according to the length of the road segment and the real-time green wave speed. In an application of the two-way green wave coordination control, the green wave speed includes a forward green wave speed and a reverse green wave speed, and the duration of green wave travel further includes a duration of forward green wave travel and a duration of reverse green wave travel. The duration of forward green wave travel for each road segment is determined based on the ratio of the length of the road segment in the forward direction to the forward green wave speed, and the duration of reverse green wave travel for each road segment is determined based on the ratio of the length of the road segment in the reverse direction to the reverse green wave speed.

For example, a duration tᵢ of forward green wave travel for the road segment between the i^{th} intersection and the (i+1)^{th} intersection is calculated according to the following formula (1):

$${t}_{i} = \frac{{d}_{i}}{{v}_{i}} \qquad ( 1 )$$

where dᵢ is a distance between the i^{th} intersection and the (i+1)^{th} intersection in the forward direction, and vᵢ is the forward green wave speed.

A duration t̅ᵢ of reverse green wave travel for the road segment between the i^{th} intersection and the (i+1)^{th} intersection is calculated according to the following formula (2):

$${\overline{t}}_{i} = \frac{{\overline{d}}_{i}}{{\overline{v}}_{i}} \qquad ( 2 )$$

where d̅ᵢ is a distance between the i^{th} intersection and the (i+1)^{th} intersection in the reverse direction, and v̅ᵢ is the reverse green wave speed.

In operation S230, a green wave coordination constraint is determined according to the intersection parameter, the green wave parameter and the duration of green wave travel.

For example, a schematic diagram of signal space-time for performing green wave coordination control may be drawn according to the intersection parameter, the green wave parameter and the duration of green wave travel. From the schematic diagram of signal space-time, the relationship between respective parameters may be obtained intuitively. An expression of a mutual constraint between respective parameters is determined according to the relationship between respective parameter, as a constraint of green wave coordination control.

In operation S240, an objective function of green wave coordination is determined according to the forward green wave bandwidth of each road segment and the reverse green wave bandwidth of each road segment.

For example, a goal of green wave coordination control is to obtain a maximum forward green wave bandwidth and a maximum reverse green wave bandwidth with the constraint. In this case, the objective function may be constructed according to the forward green wave bandwidth and the reverse green wave bandwidth. A maximum forward green wave bandwidth and a maximum reverse green wave bandwidth may be solved with the constraint. Accordingly, the target of green wave coordination control is transformed into a target of parameter optimization. The ability of performing green wave coordination control may be improved by optimizing respective parameters.

In operation S250, green wave coordination control is performed according to the constraint and the objective.

For example, a maximum forward green wave bandwidth and a maximum reverse green wave bandwidth is obtained by solving the objective function, thereby achieving the optimization of the parameters of performing green wave coordination control. By performing green wave coordination control, e.g. adjusting a configuration of the traffic light of each intersection, according to the optimized parameters, the effect of green wave coordination control may be improved.

According to the embodiments of the present disclosure, the target of green wave coordination control is transformed into a target of parameter optimization, and the green wave speed parameter has been introduced, thereby achieving a dynamic optimization based on the green wave speed, and improving a success rate of the green wave coordination.

In an application of two-way green wave coordination control, the intersection parameter includes the forward intersection parameter and the reverse intersection parameter. Table 1 shows the forward intersection parameter and the reverse intersection parameter according to the embodiments of the present disclosure.

TABLE 1

| Intersection | |
|---|---|
| Parameter | Description |
| dᵢ(d̅ᵢ̅) | The distance between the i^{th} intersection and the (i + 1)^{th} |
| | intersection in the forward (reverse) direction |
| gᵢ(g̅ᵢ̅) | The ratio (first forward ratio/first reverse ratio) of the |
| | lighting duration of the green light in the forward (reverse) |
| | coordination phase for the ith intersection to the lighting |
| | period for the ith intersection |
| rᵢ(r̅ᵢ̅) | The ratio (second forward ratio/second reverse ratio) of the |
| | lighting duration of the green light in the forward (reverse) |
| | non-coordination phase for the i^{th} intersection to the lighting |
| | period for the i^{th} intersection |
| hᵢ(h̅ᵢ̅) | The ratio of the lighting duration of the green light in the |
| | front phase for the forward (reverse) coordination phase for |
| | the i^{th} intersection to the lighting period for the i^{th} |
| | intersection |
| fᵢ(f̅ᵢ̅) | The ratio of the lighting duration of the green light in the |
| | back phase for the forward (reverse) coordination phase for |
| | the i^{th} intersection to the lighting period for the i^{th} |
| | intersection |
| τᵢ(τ̅ᵢ) | The ratio (third forward ratio/third reverse ratio) of a |
| | duration of clearing a queue in the forward (reverse) |
| | direction for the i^{th} intersection to the lighting duration of |
| | the green light in the coordination phase for the i^{th} |
| | intersection |
| tᵢ(t̅ᵢ̅) | The duration of forward green wave travel and the duration |
| | of reverse green wave travel of the road segment between |
| | the i^{th} intersection and the (i + 1)^{th} intersection |

In the application of two-way green wave coordination control, the coordination phase designated as a reference in the forward direction for vehicle driving is referred as a forward coordination phase, and a phase other than the forward coordination phase is a forward non-coordination phase. The coordination phase designated as a reference in the reverse direction for vehicle driving is referred as a reverse coordination phase. A phase other than the reverse coordination phase is a reverse non-coordination phase.

As shown in Table 1, dᵢ represents a distance between the i^{th} intersection and the (i+1)^{th} intersection in the forward direction, and d̅ᵢ represents a distance between the i^{th} intersection and the (i+1)^{th} intersection in the reverse direction.

gᵢ represents the ratio of the lighting duration of the green light in the forward coordination phase for the i^{th} intersection to the lighting period of the i^{th} intersection (i.e., the first forward ratio). g̅ᵢ represents the ratio of the lighting duration of the green light in the reverse coordination phase for the i^{th} intersection to the lighting period of the i^{th} intersection (i.e., the first reverse ratio).

rᵢ represents the ratio of the lighting duration of the green light in the forward non-coordination phase for the i^{th} intersection to the lighting period for the i^{th} intersection (i.e., the second forward ratio). r̅ᵢ̅ represents the ratio of the lighting duration of the green light in the reverse non-coordination phase for the i^{th} intersection to the lighting period for the i^{th} intersection (i.e., the second reverse ratio).

As the lighting duration of the green light in the coordination phase plus the lighting duration of the green light in the non-coordination phase is equal to the lighting period of the traffic light, the relationship between gᵢ(g̅ᵢ̅) and rᵢ(r̅ᵢ̅) is represented by the following formula (3) and formula (4):

gᵢ+rᵢ=1 (3)

g̅ᵢ̅+r̅ᵢ̅=1 (4)

In a lighting period, the green light in the coordination phase designated as a reference may be lighten in the middle of the lighting period. A non-coordination phase in which the green light is lighten before lighting the green light in the coordination phase is referred as a front phase for the coordination phase, and a non-coordination phase in which the green light is lighten after lighting the green light in the coordination phase is referred as a back phase for the coordination phase. Therefore, the lighting duration of the green light in the non-coordination phase is equal to the lighting duration of the green light in the front phase for the coordination phase plus the lighting duration of the green light in the back phase for the coordination phase.

hᵢ represents the ratio of the lighting duration of the green light in the front phase for the forward coordination phase for the i^{th} intersection to the lighting period for the i^{th} intersection. h̅ᵢ̅ represents the ratio of the lighting duration of the green light in the front phase for the reverse coordination phase for the i^{th} intersection to the lighting period for the i^{th} intersection.

fᵢ represents the ratio of the lighting duration of the green light in the back phase for the forward coordination phase for the i^{th} intersection to the lighting period for the i^{th} intersection. f̅ᵢ̅ represents the ratio of the lighting duration of the green light in the back phase for the reverse coordination phase for the i^{th} intersection to the lighting period for the i^{th} intersection.

As the lighting duration of the green light in the non-coordination phase is equal to the lighting duration of the green light in the front phase for the coordination phase plus the lighting duration of the green light in the back phase for the coordination phase, the relationship between hᵢ(h̅ᵢ̅) and fᵢ(f̅ᵢ̅) is represented by the following formulas (5) and (6):

hᵢ+fᵢ=rᵢ (5)

h̅ᵢ̅+f̅ᵢ̅=r̅ᵢ̅ (6)

τᵢ represents the ratio of a duration of clearing a queue in the forward direction for the i^{th} intersection to the lighting duration of the green light in the coordination phase for the i^{th} intersection (i.e., the third forward ratio). τ̅ᵢ̅ represents the ratio of a duration of clearing a queue in the reverse direction for the i^{th} intersection to the lighting duration of the green light in the coordination phase for the i^{th} intersection (i.e., the third reverse ratio).

The duration of clearing a queue is equal to a ratio of the length of a queue of vehicles queuing at the i^{th} intersection to a saturated flow rate. The saturated flow rate refers to a maximum volume of vehicles queuing at the i^{th} intersection that may enter the entrance of the i^{th} intersection within the lighting duration of the green light for the i^{th} intersection. A duration of clearing a queue in forward direction refers to a duration of clearing a queue in the forward direction for vehicle driving, and a duration of clearing a queue in reverse direction refers to a duration of clearing a queue in the reverse direction for vehicle driving.

In order to represent the completeness of the parameters, the duration tᵢ of forward green wave travel for the road segment between the i^{th} intersection and the (i+1)^{th} intersection and the duration t̅ᵢ̅ of reverse green wave travel for the road segment between the i^{th} intersection and the (i+1)^{th} intersection are also added to Table 1.

FIG. 3 shows a schematic diagram of the signal relationship between a coordination phase and a non-coordination phase according to an embodiment of the present disclosure.

As shown in FIG. 3, a signal segment 301 represents the ratio gᵢ of the lighting duration of the green light in the forward coordination phase for the i^{th} intersection to the lighting period of the i^{th} intersection, and a signal segment 302 represents the ratio g̅ᵢ̅ of the lighting duration of the green light in the reverse coordination phase for the i^{th} intersection to the lighting period of the i^{th} intersection.

A signal segment 311 represents the ratio hᵢ of the lighting duration of the green light in the front phase for the forward coordination phase for the i^{th} intersection to the lighting period for the i^{th} intersection, and a signal segment 312 represents the ratio hᵢ of the lighting duration of the green light in the front phase for the reverse coordination phase for the i^{th} intersection to the lighting period for the i^{th} intersection.

A signal segment 321 represents the ratio fᵢ of the lighting duration of the green light in the back phase for the forward coordination phase for the i^{th} intersection to the lighting period for the i^{th} intersection, and a signal segment 322 represents the ratio f̅ᵢ̅ of the lighting duration of the green light in the back phase for the reverse coordination phase for the i^{th} intersection to the lighting period for the i^{th} intersection.

The sum of the signal segment 311 hᵢ and the signal segment 321 fᵢ is equal to the ratio rᵢ of the lighting duration of the green light in the forward non-coordination phase for the i^{th} intersection to the lighting period for the i^{th} intersection. The sum of the signal segment 301 gᵢ, the signal segment 311 hᵢ and the signal segment 321 fᵢ is equal to 1.

The sum of the signal segment 312 h̅ᵢ̅ and the signal segment 322 f̅ᵢ̅ is equal to the ratio r̅ᵢ̅ of the lighting duration of the green light in the reverse non-coordination phase for the i^{th} intersection to the lighting period for the i^{th} intersection. The sum of the signal segment 302 g̅ᵢ̅, the signal segment 312 h̅ᵢ̅, and the signal segment 322 f̅ᵢ̅ is equal to 1.

It should be understood that when green light is lighten in the forward coordination phase represented by the signal segment 301, red light is lighten in both the front phase for the forward coordination represented by the signal segment 311 and the back phase for the forward coordination represented by the signal segment 321. Similarly, when green light is lighten in the reverse coordination phase represented by the signal segment 302, red light is lighten in both the front phase for the reverse coordination represented by the signal segment 312 and the back phase for the reverse coordination represented by the signal segment 322.

In the application of two-way green wave coordination control, the green wave parameter includes a forward green wave parameter and a reverse green wave parameter. Table 2 shows the forward green wave parameter and the reverse green wave parameter of the embodiments of the present disclosure.

TABLE 2

| Green Wave | |
|---|---|
| Parameter | Description |
| eᵢ(e̅ᵢ̅) | The time difference (forward first time difference/reverse |
| | first time difference) between a time instant at which a |
| | green wave vehicle enters the i^{th} intersection in the forward |
| | (reverse) direction and a time instant at which the green |
| | light in the forward (reverse) coordination phase of the it |
| | intersection starts to light up |
| bᵢ(b̅ᵢ̅) | The forward green wave bandwidth of the road segment |
| | between the i^{th} intersection and the (i + 1)^{th} intersection and |
| | the reverse green wave bandwidth of the road segment |
| | between the i^{th} intersection and the (i + 1)^{th} intersection |
| Δᵢ | The time difference (second time difference) between the |
| | midpoint of rᵢ and the midpoint of r̅ᵢ̅, where Δᵢ is a |
| | positive value when the midpoint of rᵢ is located after the |
| | midpoint of r̅ᵢ̅ in time |
| ϕᵢ(ϕ̅ᵢ̅) | ϕᵢ represents the time difference (forward third time |
| | difference) between the midpoint of rᵢ and the midpoint of |
| | rᵢ₊₁, and ϕ̅ᵢ̅ represents the time difference (reverse third |
| | time difference) between the midpoint of r̅ᵢ̅ and the |
| | midpoint of r̅ᵢ̅₊̅₁̅ |
| mᵢ | An integer |

As shown in Table 2, eᵢ represents the time difference (i.e. the forward first time difference) between a time instant at which a green wave vehicle (i.e. the vehicle drives at the green wave speed) enters the i^{th} intersection in the forward direction and a time instant at which the green light in the forward coordination phase of the i^{th} intersection starts to light up. e̅ᵢ̅ represents the time difference (i.e. the reverse first time difference) between a time instant at which a green wave vehicle enters the i^{th} intersection in the reverse direction and a time instant at which the green light in the reverse coordination phase of the i^{th} intersection starts to light up.

bᵢ represents the forward green wave bandwidth of the road segment between the i^{th} intersection and the (i+1)^{th} intersection, and b̅ᵢ̅ represents the reverse green wave bandwidth of the road segment between the i^{th} intersection and the (i+1)^{th} intersection.

Δᵢ is equal to a time instant at the midpoint of rᵢ minus a time instant at the midpoint of r̅ᵢ̅.

(pi is equal to a time instant at the midpoint of rᵢ₊₁ minus a time instant at the midpoint of rᵢ, and ϕ̅ᵢ̅ is equal to a time instant at the midpoint of r̅ᵢ̅ minus a time instant at the midpoint of r̅ᵢ̅₊̅₁̅.

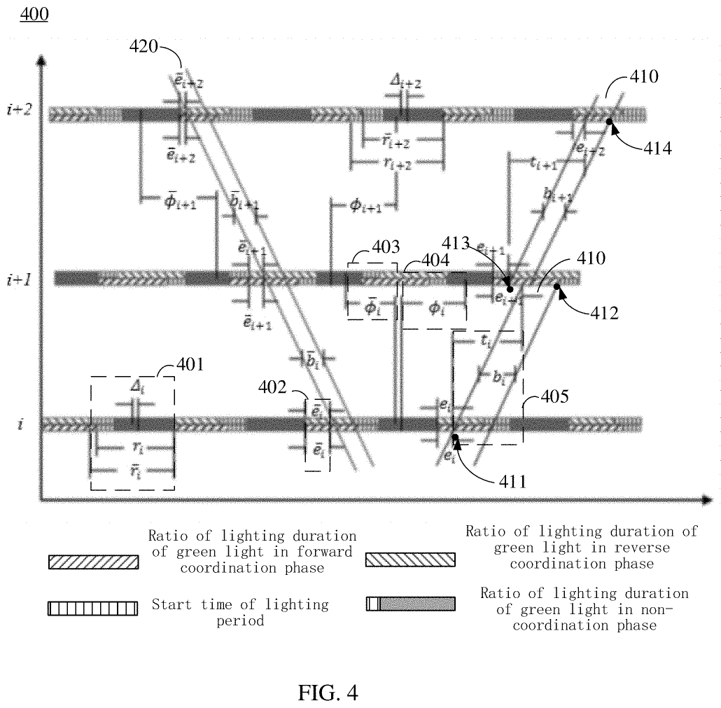

FIG. 4 shows a schematic diagram of signal space-time for the method of performing green wave coordination control according to an embodiment of the present disclosure.

As shown in FIG. 4, a schematic diagram of a signal space-time 400 is drawn according to the intersection parameter in Table 1 and the green wave parameter in Table 2. A vertical axis of the signal space-time 400 represents respective intersections (the i^{th} intersection, the (i+1)^{th} intersection and the (i+2)^{th} intersection), and a horizontal axis of the signal space-time 400 represents a lighting period of the traffic light for each intersections (referred as lighting period for short). The schematic diagram of signal space-time 400 shows 4 to 5 lighting periods of the traffic light for each intersection.

The schematic diagram of signal space-time 400 includes a forward green wave band 410 and a reverse green wave band 420. The forward green wave band 410 extends in a direction from the i^{th} intersection to the (i+1)^{th} intersection, and then to the (i+2)^{th} intersection. The forward green wave band 410 is segmented. A spot 411 on the forward green wave band 410 of the road segment between the i^{th} intersection and the (i+1)^{th} intersection is a time instant at which the green wave vehicle starts to enter the i^{th} intersection in a lighting period of the i^{th} intersection. A spot 412 is a time instant at which the lighting of the green light in the coordination phase is ended in lighting period of the (i+1)^{th} intersection. A width of a parallel band between the spot 411 and the spot 412 is the forward green wave bandwidth bᵢ of the road segment between the i^{th} intersection and the (i+1)^{th} intersection.

Similarly, a spot 413 on the forward green wave band 410 of the road segment between the (i+1)^{th} intersection and the (i+2)^{th} intersection is a time instant at which the green wave vehicle starts to enter the (i+1)^{th} intersection in a lighting period of the (i+1)^{th} intersection, and the spot 414 is a time instant at which the lighting of the green light in the coordination phase is ended in a lighting period of the (i+2)^{th} intersection. a width of a parallel band between the spot 413 and the spot 414 is the forward green wave bandwidth bᵢ₊₁ of the road segment between the (i+1)^{th} intersection and the (i+2)^{th} intersection. The forward green wave bandwidth bᵢ is not equal to the forward green wave bandwidth bᵢ₊₁.

The reverse green wave band 420 extends in a direction from the (i+2)^{th} intersection to the (i+1)^{th} intersection, and then to the i^{th} intersection. The reverse green wave band 420 is continuous. The reverse green wave bandwidth of the road segment between the (i+1)^{th} intersection and the (i+2)^{th} intersection is bᵢ₊₁, and the reverse green wave bandwidth of the road segment between the i^{th} intersection and the (i+1)^{th} intersection is bᵢ. The reverse green wave bandwidth bᵢ is equal to the reverse green wave bandwidth b_{i+1.}

For the i^{th} intersection, the ratio of lighting duration of the green light in the forward coordination phase is gᵢ among the intersection parameters in Table 1, and the ratio of lighting duration of the green light in the reverse coordination phase is gᵢ among the intersection parameters in Table 1.

As shown in a signal segment 401, the ratio of lighting duration of the green light in the non-coordination phase includes the ratio rᵢ (i.e. rᵢ among the intersection parameters in Table 1) of lighting duration of the green light in the forward non-coordination phase and the ratio r̅ᵢ̅ (i.e. r̅ᵢ̅ among the intersection parameters in Table 1) of lighting duration of the green light in the reverse non-coordination phase. Δᵢ is the time difference between the midpoint of r̅ᵢ̅ and the midpoint of r̅ᵢ̅.

As shown in a signal segment 402, in the same lighting period, the time difference between a time instant at which the green wave vehicle enters the i^{th} intersection along the reverse direction and a time instant at which the green light in the reverse coordination phase is lighten is e̅ᵢ̅ (i.e. e̅ᵢ̅ among the intersection parameters in Table 1).

As shown in a signal segment 403 and a signal segment 404, the time difference between the midpoint of r̅ᵢ̅ and the midpoint of r̅ᵢ̅₊̅₁̅ is ϕ̅ᵢ̅ (i.e. ϕ̅ᵢ̅ among the intersection parameters in Table 1), and the time difference between the midpoint of rᵢ₊₁ and the midpoint of rᵢ is ϕᵢ (i.e. ϕᵢ among the intersection parameters in Table 1).

As shown in a signal segment 405, the time width from the time instant at which the green wave vehicle enters the i^{th} intersection to the time instant at which the green wave vehicle enters the (i+1)^{th} intersection is a duration tᵢ (i.e. tᵢ in Table 1) of the forward green wave travel of the road segment between the i^{th} intersection and the (i+1)^{th} intersection.

The intersection parameters and the green wave parameters for the (i+1)^{th} intersection and the (i+2)^{th} intersection are also shown in the schematic diagram of signal space-time 400, which are not described repetitively herewith.

From the schematic diagram of signal space-time 400, the relationship between various parameters may be obtained intuitively. Accordingly, the expression of a mutual constraint between each parameter is determined accordingly to the relationship between each parameter, as a constraint of green wave coordination control.

A constraint related to the forward green wave bandwidth b̅ᵢ̅ and the reserve green wave bandwidth is referred as a constraint of bandwidth, and the constraint of bandwidth for the (i+1)^{th} intersection and the (i+2)^{th} intersection includes at least one of the following:

a sum of the forward first time difference for the i^{th} intersection and the forward green wave bandwidth of the road segment from the i^{th} intersection to the (i+1)^{th} intersection is less than or equal to the forward first ratio for the i^{th} intersection;

a sum of the reverse first time difference for the i^{th} intersection and the reverse green wave bandwidth of the road segment from the i^{th} intersection to the (i+1)^{th} intersection is less than or equal to the reverse first ratio for the i^{th} intersection;

a sum of the forward first time difference for the (i+1)^{th} intersection and the forward green wave bandwidth of the road segment from the (i+1)^{th} intersection to the (i+2)^{th} intersection is less than or equal to the forward first ratio for the (i+1)^{th} intersection; and

a sum of the reverse first time difference for the (i+1)^{th} intersection and the reverse green wave bandwidth of the road segment from the (i+1)^{th} intersection to the (i+2)^{th} intersection is less than or equal to the reverse first ratio for the (i+1)^{th} intersection.

For example, the constraint of bandwidth for the i^{th} intersection mentioned above may be expressed by the following formulas (7) to (10).

eᵢ+bᵢ≤1−rᵢ (7)

e̅ᵢ̅+b̅ᵢ̅≤1−r̅ᵢ̅ (8)

eᵢ₊₁+bᵢ≤1−rᵢ₊₁ (9)

e̅ᵢ̅₊̅₁̅+b̅ᵢ̅≤1−r̅ᵢ̅₊̅₁̅ (10)

The formula (7) represents that the sum of the forward first time difference for the i^{th} intersection and the forward green wave bandwidth of the road segment from the i^{th} intersection to the (i+1)^{th} intersection is less than or equal to the forward first ratio for the i^{th} intersection. In view of this, the time difference between a time instant at which a green wave vehicle enters the i^{th} intersection and a time instant at which the green light in the coordination phase of the i^{th} intersection starts to light up plus the bandwidth of forward green wave should be less than or equal to the lighting duration of the green light in the forward coordination phase, so as to ensure that the vehicle may pass through the i^{th} intersection within the lighting duration of the green light in the forward coordination phase. The constraints expressed by the formulas (8) to (10) are similar to the constraint of the formula (7).

In the application of two-way green wave coordination control, there is a certain constraint relationship between the forward parameter and the reverse parameter for the i^{th} intersection, which is referred as a two-way coordination constraint. The two-way coordination constraint includes constraints represented by the following formulas (11) to (16).

$${ϕ}_{i} + \overline{{ϕ}_{i}} + {Δ}_{i} - {Δ}_{i + 1} = {m}_{i} \qquad ( 11 )$$

$${Δ}_{i} = {h}_{i} - \overline{{h}_{i}} + \frac{{g}_{i} - \overline{{g}_{i}}}{2} = \frac{{h}_{i} - \overline{{h}_{i}} + \overline{{f}_{i}} - {f}_{i}}{2} \qquad ( 12 )$$

$${ϕ}_{i} + \frac{1}{2} {r}_{i + 1} + {e}_{i + 1} = \frac{1}{2} {r}_{i} + {e}_{i} + {t}_{i} \qquad ( 13 )$$

$$\overline{{ϕ}_{i}} + \frac{1}{2} \overline{{r}_{i}} + \overline{{e}_{i}} = \frac{1}{2} \overline{{r}_{i + 1}} + \overline{{e}_{i + 1}} + \overline{{t}_{i}} \qquad ( 14 )$$

$${e}_{i} \geq {τ}_{i} \qquad ( 15 )$$

$$\overline{{e}_{i + 1}} \geq \overline{{τ}_{i}} \qquad ( 16 )$$

From the schematic diagram of signal space-time 400, it may be understood that a result of the left side of the formula (11) should be a complete lighting period of the (i+1)^{th} intersection, and the result of the left side should be an integer.

The formula (12) is obtained according to the relationship between the forward (reserve) coordination phase and the front phase and the back phase for the forward (reserve) coordination phase, which may be derived by the formulas (3) to (6).

From the schematic diagram of signal space-time 400, it may be understood that the result of the left side of the formula (13) is the time width from the midpoint of rᵢ to the time instant at which the vehicle enters the (i+1)^{th} intersection. The result of the right side of the formula (13) is the time width from the midpoint of rᵢ to the time instant at which the vehicle enters the (i+1)^{th} intersection. The result of the left side is equal to the result of the right. The formula (14) is similar to the formula (13).

The formula (15) represents the time difference between the time instant at which the green wave vehicle enters the i^{th} intersection in the forward direction and the time instant at which the green light in the forward coordination phase of the i^{th} intersection starts to light up is not less than the ratio τᵢ of the duration of clearing a queue in the forward direction for the i^{th} intersection. The formula (16) is similar to the formula (15).

According to the embodiments of the present disclosure, the respective intersections may have different lighting periods, and the lighting periods may be constrained to obtain a common lighting period. In a case that the lighting period of each intersection may be scaled when drawing the signal space-time schematic diagram, the lighting period of each intersection is scaled according to the common lighting period, such that ratio of the scaled lighting period of each intersection to a common period is the same as the lighting period before scaling.

The constraint of the common lighting period is determined based on a maximum value and a minimum value among the lighting periods of the n intersections.

The constraint of the common lighting period may be expressed by the following formula (17).

$$\frac{1}{{C}_{u}} \leq z \leq \frac{1}{{C}_{l}} \qquad ( 17 )$$

where z represents an inverse of the common lighting period, Cᵤ is the maximum value of the lighting periods of the n intersections, and Cₗ is the minimum value of the lighting periods of the n intersections.

In the embodiments of the present disclosure, an optimization goal of green wave coordination control may be a goal to maximize the average weighted bandwidth of each intersection. The objective function of green wave coordination is a function determined based on a goal of maximizing the forward green wave bandwidth and the reverse green wave bandwidth of each road segment. The objective function of green wave coordination control may be expressed by the following formula (18).

$$F = max \frac{1}{n - 1} {\sum }_{i = 1}^{n - 1} [ k {b}_{i} + ( 1 - k ) {\overline{b}}_{i} ] \qquad ( 18 )$$

where bᵢ represents the forward green wave bandwidth of the road segment between the i^{th} intersection and the (i+1)^{th} intersection, bᵢ represents the reverse green wave bandwidth of the road segment between the i^{th} intersection and the (i+1)^{th} intersection, k is a weight of the forward green wave bandwidth, and (1-k) is a weight of the reverse green wave bandwidth.

According to the embodiments of the present disclosure, the target of green wave coordination control is transformed into a target of parameter optimization, and the green wave speed parameter is introduced, thereby achieving the dynamic optimization based on the green wave speed, and improving the success rate of green wave coordination.

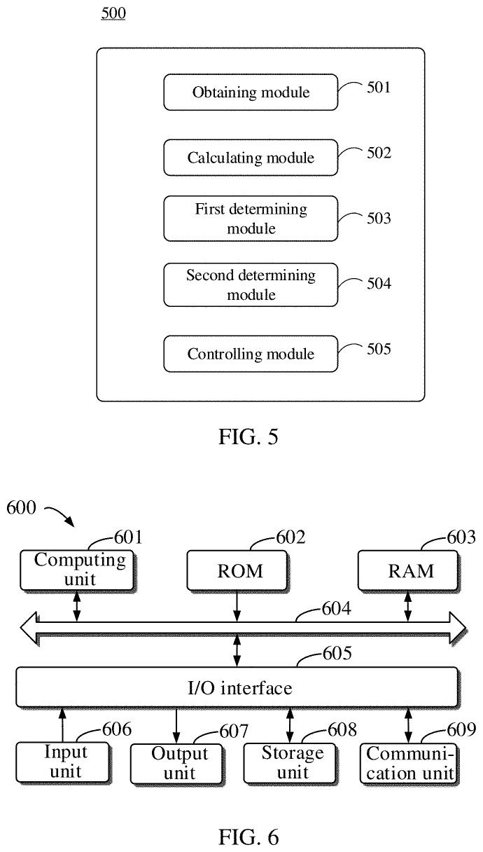

FIG. 5 shows a block diagram of an apparatus of performing green wave coordination control according to an embodiment of the present disclosure.

As shown in FIG. 5, a green wave coordination control 500 may include an obtaining module 501, a calculating module 502, a first determining module 503, a second determining module 504, and a controlling module 505.

The obtaining module 501 is configured to obtain an intersection parameter and a green wave parameter of n intersections on a preset road, wherein the green wave parameter including a forward green wave bandwidth and a reverse green wave bandwidth of each road segment between the n intersections, and n is an integer greater than or equal to two.

The calculating module 502 is configured to calculate a duration of green wave travel for each road segment according to a green wave speed for the preset road.

The first determining module 503 is configured to determine a constraint of green wave coordination according to the intersection parameter, the green wave parameter and the duration of green wave travel.

The second determining module 504 is configured to determine an objective function of green wave coordination according to the forward green wave bandwidth and the reverse green wave bandwidth of each road segment.

The controlling module 505 is configured to perform green wave coordination control according to the constraint and the objective function.

According to the embodiments of the present disclosure, each intersection includes a traffic light having a plurality of phases, the plurality of phases include a coordination phase designed as a reference and a phase other than the coordination phase. For an i^{th} intersection among the n intersections, i=1, n. The intersection parameter includes: a lighting period of the traffic light, a first ratio of a lighting duration of a green light in the coordination phase to the lighting period, a second ratio of a lighting duration of a green light in a non-coordination phase to the lighting period, and a third ratio of a duration of clearing a queue to the lighting duration of the green light in the coordination phase.

According to the embodiments of the present disclosure, the green wave parameter for the i^{th} intersection includes: a first time difference between a time instant at which a green wave vehicle enters the i^{th} intersection and a time instant at which the green light in the coordination phase of the i^{th} intersection starts to light up, a second time difference between a midpoint of the first ratio for the i^{th} intersection and a midpoint of the second ratio for the i^{th} intersection, and a third time difference between the midpoint of the second ratio for the i^{th} intersection and a midpoint of the second ratio for the (i+1)^{th} intersection.

According to the embodiments of the present disclosure, the intersection parameter includes a forward intersection parameter and a reserve intersection parameter, wherein the forward intersection parameter includes a forward first ratio, a forward second ratio and a forward third ratio, and the reverse intersection parameter includes a reverse first ratio, a reverse second ratio and a reverse third ratio; and the green wave parameter includes a forward green wave parameter and a reverse green wave parameter, wherein the forward green wave parameter includes a forward first time difference, a forward second time difference, a forward third time difference and the forward green wave bandwidth, and the reverse green wave parameter includes a reverse first time difference, a reverse second time difference, a reverse third time difference and the reverse green wave bandwidth.

According to the embodiments of the present disclosure, the duration of green wave travel includes a duration of forward green wave travel and a duration of reverse green wave travel, wherein the green wave speed includes a forward green wave speed and a reverse green wave speed, the duration of forward green wave travel of each road segment is determined based on a ratio of a length of the road segment in a forward direction to the forward green wave speed, and the duration of reverse green wave travel of each road segment is determined based on a ratio of a length of the road segment in a reverse direction to the reverse green wave speed.

The calculating module 502 includes a first calculating unit and a second calculating unit.

The first calculating unit is configured to calculate the duration tᵢ of the forward green wave travel of the road segment between the i^{th} intersection and the (i+1)^{th} intersection according to the following formula:

$${t}_{i} = \frac{{d}_{i}}{{v}_{i}}$$

where dᵢ is a distance between the i^{th} intersection and the (i+1)^{th} intersection in the forward direction, and vᵢ is the forward green wave speed.

The second calculating unit is configured to calculate the duration t̅ᵢ of the reverse green wave travel of the road segment between the i^{th} intersection and the (i+1)^{th} intersection according to the following formula:

$${\overline{t}}_{i} = \frac{{\overline{d}}_{i}}{{\overline{v}}_{i}}$$

where d̅ᵢ is a distance between the i^{th} intersection and the (i+1)^{th} intersection in the reverse direction, v̅ᵢ is the reverse green wave speed.

According to the embodiments of the present disclosure, the green wave coordination constraint include a constraint of bandwidth, and the constraint of bandwidth for the i^{th} intersection and the (i+1)^{th} intersection includes at least one of the following: a sum of the forward first time difference for the i^{th} intersection and the forward green wave bandwidth of the road segment from the i^{th} intersection to the (i+1)^{th} intersection is less than or equal to the forward first ratio for the i^{th} intersection; a sum of the reverse first time difference for the i^{th} intersection and the reverse green wave bandwidth of the road segment from the i^{th} intersection to the (i+1)^{th} intersection is less than or equal to the reverse first ratio for the i^{th} intersection; a sum of the forward first time difference for the (i+1)^{th} intersection and the forward green wave bandwidth of the road segment from the (i+1)^{th} intersection to the (i+2)^{th} intersection is less than or equal to the forward first ratio for the (i+1)^{th} intersection; and a sum of the reverse first time difference for the (i+1)^{th} intersection and the reverse green wave bandwidth of the road segment from the (i+1)^{th} intersection to the (i+2)^{th} intersection is less than or equal to the reverse first ratio for the (i+1)^{th} intersection.

The first determining module 503 is configured to determine the constraint of bandwidth according to the following formula:

eᵢ+bᵢ≤1−rᵢ

e̅ᵢ̅+b̅ᵢ̅≤1−r̅ᵢ̅

eᵢ₊₁+bᵢ≤1−rᵢ₊₁

e̅ᵢ̅₊̅₁̅+b̅ᵢ̅≤1−r̅ᵢ̅₊̅₁̅

where eᵢ represents the forward first time difference of the i^{th} intersection, and e̅ᵢ̅ represents the reverse time difference of the i^{th} intersection. bᵢ represents the forward green wave bandwidth of the road segment between the i^{th} intersection and the (i+1)^{th} intersection, and b̅ᵢ̅ represents the reverse green wave bandwidth of the road segment between the i^{th} intersection and the (i+1)^{th} intersection. e̅ᵢ̅₊̅₁̅ represents the forward first time difference of the (i+1)^{th} intersection, and e̅ᵢ̅₊̅₁̅ represents the reverse first time difference of the (i+1)^{th} intersection. rᵢ represents the forward second ratio of the i^{th} intersection, and r̅ᵢ̅ represents the reverse second ratio of the i^{th} intersection. rᵢ₊₁ represents the forward second ratio of the (i+1)^{th} intersection, and r̅ᵢ̅₊̅₁̅ represents the reverse second ratio of the (i+1)^{th} intersection.

According to the embodiments of the present disclosure, the non-coordination phase includes a front phase and a back phase, wherein in the lighting period, the green light in the front phase is lighten before lighting the green light in the coordination phase and the green light in the back phase is lighten after lighting the green light in the coordination phase, the lighting duration of the green light in the non-coordination phase is equal to the lighting duration of the green light in the front phase for the coordination phase plus the lighting duration of the green light in the back phase; and the coordination phase includes a forward coordination phase and a reverse coordination phase.

The forward second ratio for the i^{th} intersection is equal to a ratio of the lighting duration of the green light in the front phase for the forward coordination phase to the lighting period plus a ratio of the lighting duration of the green light in the back phase for the forward coordination phase to the lighting period; and wherein the reverse second ratio for the i^{th} intersection is equal to a ratio of the lighting duration of the green light in the front phase for the reverse coordination phase to the lighting period plus a ratio of the lighting duration of the green light in the back phase for the reverse coordination phase to the lighting period.

According to the embodiments of the present disclosure, the constraint of the green wave coordination further includes a constraint of two-way coordination. The first determining module 503 is configured to determine the constraint of two-way coordination according to the following formula:

$$\begin{matrix}{ϕ}_{i} + \overline{{ϕ}_{i}} + {Δ}_{i} - {Δ}_{i + 1} = {m}_{i} \\ {Δ}_{i} = {h}_{i} - \overline{{h}_{i}} + \frac{{g}_{i} - \overline{{g}_{i}}}{2} = \frac{{h}_{i} - \overline{{h}_{i}} + \overline{{f}_{i}} - {f}_{i}}{2} \\ {ϕ}_{i} + \frac{1}{2} {r}_{i + 1} + {e}_{i + 1} = \frac{1}{2} {r}_{i} + {e}_{i} + {t}_{i} \\ \overline{{ϕ}_{i}} + \frac{1}{2} \overline{{r}_{i}} + \overline{{e}_{i}} = \frac{1}{2} \overline{{r}_{i + 1}} + \overline{{e}_{i + 1}} + \overline{{t}_{i}} \\ {e}_{i} \geq {τ}_{i} \\ \overline{{e}_{i + 1}} \geq \overline{{τ}_{i}}\end{matrix}$$

where Δᵢ represents the forward second time difference for the i^{th} intersection, Δᵢ₊₁ represents the forward second time difference for the (i+1)^{th} intersection, mᵢ is an integer, ϕᵢ represents the forward third time difference for the i^{th} intersection, ϕ̅ᵢ̅ represents the reverse third time difference for the i^{th} intersection, tᵢ represents the duration of forward green wave travel of the road segment between the i^{th} intersection and the (i+1)^{th} intersection, t̅ᵢ̅ represents the duration of reverse green wave travel of the road segment between the i^{th} intersection and the (i+1)^{th} intersection, τᵢ represents the forward third ratio for the i^{th} intersection, τ̅ᵢ̅ represents the reverse third ratio for the i^{th} intersection, gᵢ represents the forward first ratio for the i^{th} intersection, g̅ᵢ̅ represents the reverse first ratio for the i^{th} intersection, hᵢ represents the ratio of the lighting duration of the green light in the front phase for the forward coordination phase to the lighting period for the i^{th} intersection, h̅ᵢ̅ represents the ratio of the lighting duration of the green light in the front phase for the reverse coordination phase to the lighting period for the i^{th} intersection, fᵢ represents the ratio of the lighting duration of the green light in the back phase for the forward coordination phase to the lighting period for the i^{th} intersection, and f̅ᵢ̅ represents the ratio of the lighting duration of the green light in the back phase for the reverse coordination phase to the lighting period for the i^{th} intersection.

According to the embodiments of the present disclosure, the constraint of the green wave coordination further includes a constraint of a common lighting period, wherein the constraint of the common lighting period is determined based on a maximum value among the lighting periods of the n intersections and a minimum value among the lighting periods of the n intersections.

The first determining module 503 is further configured to determine the constraint of the common lighting period according to the following formula:

$$\frac{1}{{C}_{u}} \leq z \leq \frac{1}{{C}_{l}}$$

where z represents the inverse of the common lighting period, Cᵤ is the maximum value of the lighting period of the n intersections, and Cₗ is the minimum value of the lighting period of the n intersections.

According to the embodiments of the present disclosure, the objective function of green wave coordination is a function determined based on a goal of maximizing the forward green wave bandwidth and the reverse green wave bandwidth of each road segment. The second determining module 503 is configured to determine the objective function F according to the following formula:

$$F = max \frac{1}{n - 1} {\sum }_{i = 1}^{n - 1} [ k {b}_{i} + ( 1 - k ) {\overline{b}}_{i} ]$$

where bᵢ represents the forward green wave bandwidth of the road segment between the i^{th} intersection and the (i+1)^{th} intersection, and bᵢ represents the reverse green wave bandwidth of the road segment between the i^{th} intersection and the (i+1)^{th} intersection. k is the weight of the forward green wave bandwidth, and (1-k) is the weight of the reverse green wave bandwidth.

According to the embodiments of the present disclosure, the present disclosure further provides an electronic device, a readable storage medium, and a computer program product.

FIG. 6 shows a schematic block diagram of an example electronic device 600 that may be used to implement the embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 6, the electronic device 600 may include computing unit 601, which may perform various appropriate actions and processing based on a computer program stored in a read-only memory (ROM) 602 or a computer program loaded from a storage unit 608 into a random access memory (RAM) 603. Various programs and data required for the operation of the electronic device 600 may be stored in the RAM 603. The computing unit 601, the ROM 602 and the RAM 603 are connected to each other through a bus 604. An input/output (I/O) interface 605 is further connected to the bus 604.

Various components in the electronic device 600 connected with I/O interface 605, including an input unit 606, such as a keyboard, a mouse, etc.; an output unit 607, such as various types of displays, speakers, etc.; a storage unit 608, such as a magnetic disk, an optical disk, etc.; and a communication unit 609, such as a network card, a modem, a wireless communication transceiver, etc. The communication unit 609 allows the electronic device 600 to exchange information/data with other devices through a computer network such as the Internet and/or various telecommunication networks.

The computing unit 601 may be various general-purpose and/or special-purpose processing components with processing and computing capabilities. Some examples of the computing unit 601 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 601 may perform the various methods and processes described above, such as the method of performing green wave coordination control. For example, in some embodiments, the method of performing green wave coordination control may be implemented as a computer software program that is tangibly contained on a machine-readable medium, such as a storage unit 608. In some embodiments, part or all of a computer program may be loaded and/or installed on the electronic device 600 via the ROM 602 and/or the communication unit 609. When the computer program is loaded into the RAM 603 and executed by the computing unit 601, one or more steps of the method of performing green wave coordination control described above may be performed. Alternatively, in other embodiments, the computing unit 601 may be configured to perform the method of performing green wave coordination control in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a dedicated or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user, and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other. The server may be a cloud server, also referred to as a cloud computing server. The server may also be a server of a distributed system, or a server combined with a block-chain.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-mentioned specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

1. A method of performing green wave coordination control, comprising:
obtaining an intersection parameter and a green wave parameter of n intersections on a preset road, wherein the green wave parameter comprises a forward green wave bandwidth and a reverse green wave bandwidth of each road segment between the n intersections, and n is an integer greater than or equal to 2;
calculating a duration of green wave travel for each road segment according to a green wave speed for the preset road;
determining a constraint of green wave coordination according to the intersection parameter, the green wave parameter and the duration of green wave travel;
determining an objective function of green wave coordination according to the forward green wave bandwidth and the reverse green wave bandwidth of each road segment; and
performing green wave coordination control according to the constraint and the objective function.

2. The method of claim 1, wherein each intersection comprises a traffic light having a plurality of phases, the plurality of phases comprising a coordination phase designated as a reference and a phase other than the coordination phase;
for an i^{th} intersection among the n intersections, i=1, . . . , n, the intersection parameter comprises: a lighting period of the traffic light, a first ratio of a lighting duration of a green light in the coordination phase to the lighting period, a second ratio of a lighting duration of a green light in a non-coordination phase to the lighting period, and a third ratio of a duration of clearing a queue to the lighting duration of the green light in the coordination phase.

3. The method of claim 2, wherein, the green wave parameter for the i^{th} intersection comprises: a first time difference between a time instant at which a green wave vehicle enters the i^{th} intersection and a time instant at which the green light in the coordination phase of the i^{th} intersection starts to light up, a second time difference between a midpoint of the first ratio for the i^{th} intersection and a midpoint of the second ratio for the i^{th} intersection, and a third time difference between the midpoint of the second ratio for the i^{th} intersection and a midpoint of the second ratio for the (i+1)^{th} intersection.

4. The method of claim 3, wherein:
the intersection parameter comprises a forward intersection parameter and a reserve intersection parameter, wherein the forward intersection parameter comprises a forward first ratio, a forward second ratio and a forward third ratio, and the reverse intersection parameter comprises a reverse first ratio, a reverse second ratio and a reverse third ratio; and
the green wave parameter comprises a forward green wave parameter and a reverse green wave parameter, wherein the forward green wave parameter comprises a forward first time difference, a forward second time difference, a forward third time difference and the forward green wave bandwidth, and the reverse green wave parameter comprises a reverse first time difference, a reverse second time difference, a reverse third time difference and the reverse green wave bandwidth.

5. The method of claim 4, wherein the duration of green wave travel comprises a duration of forward green wave travel and a duration of reverse green wave travel, wherein the green wave speed comprises a forward green wave speed and a reverse green wave speed, the duration of forward green wave travel of each road segment is determined based on a ratio of a length of the road segment in a forward direction to the forward green wave speed, and the duration of reverse green wave travel of each road segment is determined based on a ratio of a length of the road segment in a reverse direction to the reverse green wave speed.

6. The method of claim 5, wherein the constraint of green wave coordination comprises a constraint of bandwidth, and the constraint of bandwidth for the i^{th} intersection and the (i+1)^{th} intersection comprises at least one of the following:
a sum of the forward first time difference for the i^{th} intersection and the forward green wave bandwidth of the road segment from the i^{th} intersection to the (i+1)^{th} intersection is less than or equal to the forward first ratio for the i^{th} intersection;
a sum of the reverse first time difference for the i^{th} intersection and the reverse green wave bandwidth of the road segment from the i^{th} intersection to the (i+1)^{th} intersection is less than or equal to the reverse first ratio for the i^{th} intersection;
a sum of the forward first time difference for the (i+1)^{th} intersection and the forward green wave bandwidth of the road segment from the (i+1)^{th} intersection to the (i+2)^{th} intersection is less than or equal to the forward first ratio for the (i+1)^{th} intersection; and
a sum of the reverse first time difference for the (i+1)^{th} intersection and the reverse green wave bandwidth of the road segment from the (i+1)^{th} intersection to the (i+2)^{th} intersection is less than or equal to the reverse first ratio for the (i+1)^{th} intersection.

7. The method of claim 6, wherein the non-coordination phase comprises a front phase and a back phase, wherein in the lighting period, the green light in the front phase is lighten before lighting the green light in the coordination phase and the green light in the back phase is lighten after lighting the green light in the coordination phase; the lighting duration of the green light in the non-coordination phase is equal to the lighting duration of the green light in the front phase for the coordination phase plus the lighting duration of the green light in the back phase; and the coordination phase comprises a forward coordination phase and a reverse coordination phase; and
wherein the forward second ratio for the i^{th} intersection is equal to a ratio of the lighting duration of the green light in the front phase for the forward coordination phase to the lighting period plus a ratio of the lighting duration of the green light in the back phase for the forward coordination phase to the lighting period; and
wherein the reverse second ratio for the i^{th} intersection is equal to a ratio of the lighting duration of the green light in the front phase for the reverse coordination phase to the lighting period plus a ratio of the lighting duration of the green light in the back phase for the reverse coordination phase to the lighting period.

8. The method of claim 7, wherein the constraint of green wave coordination further comprises a constraint of two-way coordination; and the determining the constraint of green wave coordination comprises:
determining the constraint of two-way coordination according to the following formula:
$$\begin{matrix}{ϕ}_{i} + \overline{{ϕ}_{i}} + {Δ}_{i} - {Δ}_{i + 1} = {m}_{i} \\ {Δ}_{i} = {h}_{i} - \overline{{h}_{i}} + \frac{{g}_{i} - \overline{{g}_{i}}}{2} = \frac{{h}_{i} - \overline{{h}_{i}} + \overline{{f}_{i}} - {f}_{i}}{2} \\ {ϕ}_{i} + \frac{1}{2} {r}_{i + 1} + {e}_{i + 1} = \frac{1}{2} {r}_{i} + {e}_{i} + {t}_{i} \\ \overline{{ϕ}_{i}} + \frac{1}{2} \overline{{r}_{i}} + \overline{{e}_{i}} = \frac{1}{2} \overline{{r}_{i + 1}} + \overline{{e}_{i + 1}} + \overline{{t}_{i}} \\ {e}_{i} \geq {τ}_{i} \\ \overline{{e}_{i + 1}} \geq \overline{{τ}_{i}}\end{matrix}$$
wherein, Δᵢ represents the forward second time difference for the i^{th} intersection, represents the forward second time difference for the (i+1)^{th} intersection, mᵢ is an integer, ϕᵢ represents the forward third time difference for the i^{th} intersection, ϕ̅ᵢ̅ represents the reverse third time difference for the i^{th} intersection, tᵢ represents the duration of forward green wave travel of the road segment between the i^{th} intersection and the (i+1)^{th} intersection, t̅ᵢ̅ represents the duration of reverse green wave travel of the road segment between the i^{th} intersection and the (i+1)^{th} intersection, τᵢ represents the forward third ratio for the i^{th} intersection, τ̅ᵢ̅ represents the reverse third ratio for the i^{th} intersection, gᵢ represents the forward first ratio for the i^{th} intersection, g̅ᵢ̅ represents the reverse first ratio for the i^{th} intersection, hᵢ represents the ratio of the lighting duration of the green light in the front phase for the forward coordination phase to the lighting period for the i^{th} intersection, h̅ᵢ̅ represents the ratio of the lighting duration of the green light in the front phase for the reverse coordination phase to the lighting period for the i^{th} intersection, fᵢ represents the ratio of the lighting duration of the green light in the back phase for the forward coordination phase to the lighting period for the i^{th} intersection, and f̅ᵢ̅ represents the ratio of the lighting duration of the green light in the back phase for the reverse coordination phase to the lighting period for the i^{th} intersection.

9. The method of claim 6, wherein the constraint of green wave coordination further comprises a constraint of common lighting period, the constraint of common lighting period is determined based on a maximum value among the lighting periods of the n intersections and a minimum value among the lighting periods of the n intersections.

10. The method of claim 1, wherein the objective function of green wave coordination is a function determined based on a goal of maximizing the forward green wave bandwidth and the reverse green wave bandwidth of each road segment.

11-20. (canceled)

21. An electronic device, comprising:
at least one processor; and
a memory, communicatively coupled with the at least one processor;
wherein the memory stores instructions executable by the at least one processor, and the instructions, when executed by the at least one processor, cause the at least one processor to perform the method of claim 1.

22. A non-transitory computer readable storage medium storing computer instructions, wherein the computer instructions are configured to cause a computer to perform the method of claim 1.

23. (canceled)

24. The electronic device of claim 21, wherein each intersection comprises a traffic light having a plurality of phases, the plurality of phases comprising a coordination phase designated as a reference and a phase other than the coordination phase;
for an i^{th} intersection among the n intersections, i=1, . . . , n, the intersection parameter comprises: a lighting period of the traffic light, a first ratio of a lighting duration of a green light in the coordination phase to the lighting period, a second ratio of a lighting duration of a green light in a non-coordination phase to the lighting period, and a third ratio of a duration of clearing a queue to the lighting duration of the green light in the coordination phase.

25. The electronic device of claim 24, wherein, the green wave parameter for the i^{th} intersection comprises: a first time difference between a time instant at which a green wave vehicle enters the i^{th} intersection and a time instant at which the green light in the coordination phase of the i^{th} intersection starts to light up, a second time difference between a midpoint of the first ratio for the i^{th} intersection and a midpoint of the second ratio for the i^{th} intersection, and a third time difference between the midpoint of the second ratio for the i^{th} intersection and a midpoint of the second ratio for the (i+1)^{th} intersection.

26. The electronic device of claim 25, wherein:
the intersection parameter comprises a forward intersection parameter and a reserve intersection parameter, wherein the forward intersection parameter comprises a forward first ratio, a forward second ratio and a forward third ratio, and the reverse intersection parameter comprises a reverse first ratio, a reverse second ratio and a reverse third ratio; and
the green wave parameter comprises a forward green wave parameter and a reverse green wave parameter, wherein the forward green wave parameter comprises a forward first time difference, a forward second time difference, a forward third time difference and the forward green wave bandwidth, and the reverse green wave parameter comprises a reverse first time difference, a reverse second time difference, a reverse third time difference and the reverse green wave bandwidth.

27. The electronic device of claim 26, wherein the duration of green wave travel comprises a duration of forward green wave travel and a duration of reverse green wave travel, wherein the green wave speed comprises a forward green wave speed and a reverse green wave speed, the duration of forward green wave travel of each road segment is determined based on a ratio of a length of the road segment in a forward direction to the forward green wave speed, and the duration of reverse green wave travel of each road segment is determined based on a ratio of a length of the road segment in a reverse direction to the reverse green wave speed.

28. The electronic device of claim 27, wherein the constraint of green wave coordination comprises a constraint of bandwidth, and the constraint of bandwidth for the i^{th} intersection and the (i+1)^{th} intersection comprises at least one of the following:
a sum of the forward first time difference for the i^{th} intersection and the forward green wave bandwidth of the road segment from the i^{th} intersection to the (i+1)^{th} intersection is less than or equal to the forward first ratio for the i^{th} intersection;
a sum of the reverse first time difference for the i^{th} intersection and the reverse green wave bandwidth of the road segment from the i^{th} intersection to the (i+1)^{th} intersection is less than or equal to the reverse first ratio for the i^{th} intersection;
a sum of the forward first time difference for the (i+1)^{th} intersection and the forward green wave bandwidth of the road segment from the (i+1)^{th} intersection to the (i+2)^{th} intersection is less than or equal to the forward first ratio for the (i+1)^{th} intersection; and
a sum of the reverse first time difference for the (i+1)^{th} intersection and the reverse green wave bandwidth of the road segment from the (i+1)^{th} intersection to the (i+2)^{th} intersection is less than or equal to the reverse first ratio for the (i+1)^{th} intersection.

29. The electronic device of claim 28, wherein the non-coordination phase comprises a front phase and a back phase, wherein in the lighting period, the green light in the front phase is lighten before lighting the green light in the coordination phase and the green light in the back phase is lighten after lighting the green light in the coordination phase; the lighting duration of the green light in the non-coordination phase is equal to the lighting duration of the green light in the front phase for the coordination phase plus the lighting duration of the green light in the back phase; and the coordination phase comprises a forward coordination phase and a reverse coordination phase; and
wherein the forward second ratio for the i^{th} intersection is equal to a ratio of the lighting duration of the green light in the front phase for the forward coordination phase to the lighting period plus a ratio of the lighting duration of the green light in the back phase for the forward coordination phase to the lighting period; and
wherein the reverse second ratio for the i^{th} intersection is equal to a ratio of the lighting duration of the green light in the front phase for the reverse coordination phase to the lighting period plus a ratio of the lighting duration of the green light in the back phase for the reverse coordination phase to the lighting period.

30. The electronic device of claim 29, wherein the constraint of green wave coordination further comprises a constraint of two-way coordination; and
the at least one processor is further configured to:
determine the constraint of two-way coordination according to the following formula:
$$\begin{matrix}{ϕ}_{i} + \overline{{ϕ}_{i}} + {Δ}_{i} - {Δ}_{i + 1} = {m}_{i} \\ {Δ}_{i} = {h}_{i} - \overline{{h}_{i}} + \frac{{g}_{i} - \overline{{g}_{i}}}{2} = \frac{{h}_{i} - \overline{{h}_{i}} + \overline{{f}_{i}} - {f}_{i}}{2} \\ {ϕ}_{i} + \frac{1}{2} {r}_{i + 1} + {e}_{i + 1} = \frac{1}{2} {r}_{i} + {e}_{i} + {t}_{i} \\ \overline{{ϕ}_{i}} + \frac{1}{2} \overline{{r}_{i}} + \overline{{e}_{i}} = \frac{1}{2} \overline{{r}_{i + 1}} + \overline{{e}_{i + 1}} + \overline{{t}_{i}} \\ {e}_{i} \geq {τ}_{i} \\ \overline{{e}_{i + 1}} \geq \overline{{τ}_{i}}\end{matrix}$$
wherein, Δᵢ represents the forward second time difference for the i^{th} intersection, Δᵢ₊₁ represents the forward second time difference for the (i+1)^{th} intersection, mᵢ is an integer, ϕᵢ represents the forward third time difference for the i^{th} intersection, ϕ̅ᵢ̅ represents the reverse third time difference for the i^{th} intersection, tᵢ represents the duration of forward green wave travel of the road segment between the i^{th} intersection and the (i+1)^{th} intersection, t̅ᵢ̅ represents the duration of reverse green wave travel of the road segment between the i^{th} intersection and the (i+1)^{th} intersection, τᵢ represents the forward third ratio for the i^{th} intersection, τ̅ᵢ̅ represents the reverse third ratio for the i^{th} intersection, gᵢ represents the forward first ratio for the i^{th} intersection, g̅ᵢ̅ represents the reverse first ratio for the i^{th} intersection, hᵢ represents the ratio of the lighting duration of the green light in the front phase for the forward coordination phase to the lighting period for the i^{th} intersection, h̅ᵢ̅ represents the ratio of the lighting duration of the green light in the front phase for the reverse coordination phase to the lighting period for the i^{th} intersection, fᵢ represents the ratio of the lighting duration of the green light in the back phase for the forward coordination phase to the lighting period for the i^{th} intersection, and is represents the ratio of the lighting duration of the green light in the back phase for the reverse coordination phase to the lighting period for the i^{th} intersection.

31. The electronic device of claim 28, wherein the constraint of green wave coordination further comprises a constraint of common lighting period, the constraint of common lighting period is determined based on a maximum value among the lighting periods of the n intersections and a minimum value among the lighting periods of the n intersections;
wherein the objective function of green wave coordination is a function determined based on a goal of maximizing the forward green wave bandwidth and the reverse green wave bandwidth of each road segment.
